(19) United States
(12) Patent Application Publication
(10) Pub. No.: US 2003/0203980 A1
(43) Pub. Date: Oct. 30, 2003

(54) Sol-gel composition, methods for manufacturing sol-gels, and applications for sol-gels

(76) Inventor: Reynaldo A. Valdes, Port Charlotte, FL (US)

Correspondence Address: LERNER AND GREENBERG, P.A., POST OFFICE BOX 2480, HOLLYWOOD, FL, 33022-2480, US

(21) Appl. No.: 10/135,685

(22) Filed: Apr. 30, 2002

(51) Int. Cl. C09K 3/00

(52) U.S. Cl. 516/99

(57) ABSTRACT

A process makes shelf stable aqueous sol-gel complexes. Preferably, the sol-gel has the formula:

—N(x)₂-[(TiOH₄)—O]ₙ—,

wherein x is an alkyl group; and n is an ordinal number. The sol-gel complexes form useful ultraviolet light, mildew and water resistant thin film protective coatings and chemical intermediates.

### BACKGROUND OF THE INVENTION

1. Field of the Invention

The invention relates to sol-gel compositions and methods for manufacturing sol-gels, especially those containing C2-C4 tetrafunctional titanates. The invention also relates to applications for the sol-gels.

2. Description of the Related Art

Uncoated plants are more susceptible to damage and disease. Invasive microorganisms attack grapes and cucurbits (e.g. squash, cucumber, gourds, pumpkins, cantaloupes, and watermelons). Disease can spread readily throughout the field by wind borne spores and can lead to unhealthy environmental conditions that are unfavorable for development. Wind borne soil can damage and abrade unprotected epidermal plant tissue causing damage. The damaged plant tissue is often a pathway for invasive microorganisms such as powdery mildew.

Uncoated plants can absorb pesticides. The plant absorbs some pesticides and unless metabolized by the plant may be translocated to the fruit or vegetable. For example, scientists from the University of Adelaide in Australia discovered high concentrations of sodium chloride in samples of juice and wines caused by overhead irrigation with saline water. Studies found that the saline water was absorbed through the foliage and then translocated to the berry.

Likewise, uncoated plants can be damaged by ultraviolet (UV) radiation. The Environmental Protection Agency has found that absorption of UV radiation varies widely from one organism to the next. In general, UV radiation decreases plant growth by reducing leaf size, and, therefore, limiting the area available for energy capture. Plant stunting and a reduction in total dry weight are also typically seen in UV-irradiated plants.

However, reliable scientific information on the effects of UV on plants is limited. Only four out of ten terrestrial plant ecosystems (temperate forest, agricultural, temperate grassland, tundra, and alpine ecosystem) have been studied. In addition, much of the existing data came from greenhouses where plants are more sensitive to UV-B than those grown outdoors.

Studies at the University of Maryland have found that two thirds of the plants studied displayed some degree of UV sensitivity and there are indications that some weeds are more UV-B resistant. Some research has suggested that twenty-five percent (25%) ozone depletion could result in a comparable reduction of total soybean yield.

Plant defense responses include the hypersensitive response; synthesis of phytoalexins (small antimicrobial compounds), lignification of plant cell walls, synthesis of lytic enzymes such as chitinases and glucanases, an oxidative burst (release of active oxygen species), and expression of a plethora of pathogenesis related proteins and transcripts of unknown function. Plants can suffer loss of significant fractions of the plant body without dire consequences for the survival of the organism. This allows infected cells that are killed along with the pathogen to be effective as a plant defense response.

Elucidation of the regulatory mechanisms controlling expression of these defense responses, and the extent, to which particular responses are effective in protecting plants, is important for the design of strategies to improve plant defenses.

Against the backdrop of the research on damage to uncoated plants, research has been conducted on sol-gels. The technical literature dealing with sol-gel technology has increased dramatically since 1980 as scientists and engineers have developed a variety of techniques to use sol-gels to prepare fibers, monoliths, microspheres, thin films, and fine powders. In turn, these structures have been applied in diverse fields such as protective coatings, catalysts, piezoelectric devices, wave guides, optical fibers, lenses, high strength ceramics, specialty glasses, and nuclear waste encapsulation.

This diversity stems from the flexibility of sol-gel technology. Sol-gel technology allows one to engineer unique multicomponent oxide systems on a molecular level and manipulate process parameters to achieve desired end-product properties.

Sol-gel processes offer certain advantages over the conventional high temperature fusion and vapor deposition routes. These advantages include the following: simplicity, ultra-high homogeneity, high purity, narrow particle size distributions, facile routes to multicomponent systems, low energy requirements, and low capital investment.

Generally, metal oxides can be prepard via the sol-gel method by following three basic steps. The first step is partial hydrolysis of a metal alkoxide to form reactive monomers. Next, these monomers are polycondensated to form colloid like oligomers (sol formation). In the next step, the colloid-like oligomers undergo additional hydrolysis to promote polymerization and crosslinking leading to a three-dimensional matrix and gel formation. Although treated here in a sequential fashion for the sake of clarity, these reactions do occur simultaneously at various stages of the overall process. These steps can be summarized in the following text.

During this stage the sol reacts with excess water that may already be present. The water can added in a second step or even taken from moisture in the air. This causes the hydrolysis of the less active, pendant alkoxy groups on the -MOMO- backbone forming reactive -MOH groups. The presence of these active sites now allows crosslinking among oligomeric chains. Using polysiloxane as an example, as polymerization and crosslinking progresses, the viscosity of the sol gradually increases until the sol-gel transition point is reached. At the sol-gel transition point, the viscosity abruptly increases and gelation occurs.

The widespread utility of sol-gel technology is largely because each of these reactions can be controlled. Several parameters that influence hydrolysis and polymer growth and determine the nature of the gel microstructure are pH, alkoxide concentration, alkoxide type, water to alkoxide ratio, catalyst, solvent, time, and temperature. The gel microstructure, in turn, determines the morphology (size, shape, and porosity) of the final oxide particle, whether it is present in a fiber, powder, or coating.

Densification influences the properties of the sol-gel. To achieve full densification (total condensation), the isolated gel must be heated above its glass transition temperature (T_{g}). The densification rate and transition (sintering) temperature are influenced primarily by the morphology and composition of the gel, both of which are a function of the processing parameters used to effect gelation.

Silicate glasses are described in detail in the prior art. In particular, the prior art describes preparation of single and multicomponent silicate gels. A general base-catalyzed route for the preparation of silica gel entails adding an alkylsilicate to an alcoholic solution of NaOMe or NaOH, followed by rapid addition of water. Gel formation occurs in minutes to days. An acid-catalyzed route entails the addition of dilute, aqueous HCl, Acetic, or Oxalic acid to a solution of the alkylsilicate in alcohol. Gelation occurs more slowly in the acid medium, requiring hours to days.

Multicomponent oxide systems are also known. Because different alkoxides, have unequal rates of hydrolysis and condensation, the possibility of nonhomogenious preparation of multicomponent oxides must be considered as a potential problem. Alcoholic solutions of tetraethylsilicate, for example, when treated with water can remain clear mobile liquids (sols) for months.

The prior art shows how to prepare aqueous titanate solutions from titanium chelates. Examples of titanium chelates include titanium acecylacetonate, triethanolamine titanate, titanium lactic acid chelate, and compounds including ten (10) weight parts of isopropyl titanate admixed to twenty (20) weight parts of glacial acetic acid, which is admixed to seventy (70) weight parts of water. Such solutions are only stable for several days and may not be useful when the presence of acid is undesirable or turbidity develops.

Older references have not detailed non-silicate sol-gel syntheses. Recent references have begun to consider non-silicate sol-gels.

### SUMMARY OF THE INVENTION

It is accordingly an object of the invention to provide sol-gel compositions, methods for manufacturing sol-gels, and applications for sol-gels that overcome the above-mentioned disadvantages of the heretofore-known compositions and methods of this general type.

With the foregoing and other objects in view there is provided, in accordance with the invention, a method for manufacturing a sol-gel. The first step of the method involves providing a dialkylamine. The next step is mixing the dialkylamine with an alkoxide. The next step is admixing water to form hydrolyzed gelatinous agglomerate. The next step is heating and stirring the hydrolyzed gelatinous agglomerate until the hydrolyzed gelatinous agglomerate becomes transparent. Preferably, two molar weight parts of the dialkylamine are used for each molar weight part of the alkoxide and at least twenty-nine molar weights of water are also added for each molar weight of the diethylamine. The method can also include filtering out any undissolved particles from the translucent hydrolyzed gelatinous agglomerate.

The metal alkoxide used in the method is preferably a C2 to C4 tetrafunctional titanate and is most preferably tetraisopropyl titanate. Other possible tetrafunctional titanate include tetraethyl, tetrapropyl, and tetrabutyl titanate.

To provide a solution, for use the translucent hydrolyzed gelatinous agglomerate may be diluted with up to 100 volumes of water.

The dialkylamine in the method is preferably diethylamine. With the objects of the invention in view, there is also provided a sol-gel having the formula

—N(x)₂-[(TiOH₄)—O]ₙ—,

wherein x is an alkyl group, and n is an ordinal number. Preferably, x is selected from the group including methyl, ethyl, propyl, and/or butyl groups. Preferably, the sol gel is a compound where n equals 4.

In accordance with a further object of the invention, the sol-gel is formed by the previously described method.

In accordance with a further object of the invention, a method for forming a protective barrier for a plant includes coating a plant with a sol-gel having the formula:

—N(x)₂-[(TiOH₄)—O]ₙ—,

wherein x is an alkyl group, and n is an ordinal number.

In accordance with a further object of the invention, a method for protecting tile and/or grout includes coating a tile and/or grout with a sol-gel having the formula:

—N(x)₂-[(TiOH₄)—O]ₙ—

wherein x is an alkyl group, and n is an ordinal number. The sol-gel can forms a fungus-resistant coating over tile and grout as well as organic substrates.

In accordance with a further object of the invention, a method for carrying ultraviolet-light-sensitive pesticides includes adding an ultraviolet-light-sensitive pesticide to a sol-gel having the formula:

—N(x)₂-[(TiOH₄)—O]ₙ—,

wherein x is an alkyl group; and n is an ordinal number.

In accordance with a further object of the invention, a method for preparing fluoropolymer dispersions includes providing a fluoropolymer dispersion, adding a sol-gel having the formula:

—N(x)₂-[(TiOH₄)—O]ₙ—

wherein x is an alkyl group, and n is an ordinal number. Preferably, a concentration of sol-gel is maintained between 0.1% and 5.0% weight percent of the total weight of the fluorocarbon dispersion.

In accordance with a further object of the invention, modified aqueous multifunctional sol-gel compositions, that may be used neet or further diluted and incorporated into water dispersible compounds or aqueous polymer dispersions.

In accordance with a further object of the invention, the method can be conducted under normal atmospheric conditions. Therefore, the invention eliminates the expense of compounding sensitive alkoxides of titanium in an inert atmosphere.

In accordance with a further object of the invention, the sol-gel complexes are to be made without densification processes.

In accordance with a further object of the invention, transparent titanate films form aqueous systems for use as agrochemical thin film barrier compounds. The sol-gels are useful for forming agrochemical barriers because they are multifunctional and inexpensive.

Under similar conditions, the more sensitive alkoxides of titanium, zirconium, or aluminum for instance, will immediately precipitate their hydrated oxides. These and other problems are solved by this invention.

In accordance with a further object of the invention, the sol-gel is unlike antitranspirants, which block plant foliar exchange of gases. Accordingly, the sol-gel is a thin film coating that is porous to oxygen and carbon dioxide gasses but beads water and resists removal by rain.

In accordance with a further object of the invention, the sol-gel coatings dries quickly without the need for sintering or in-situ curing and imparts UV, mildew, and water resistance to the coated surface. The sol-gels of the invention are alkaline, shelf-stable, have a high pH, and will not become turbid or polymerize when stored.

The object of this invention is to provide modified aqueous multifunctional sol-gel compositions that may be used neat or further diluted or incorporated into water dispersible compounds or aqueous polymer dispersions.

In accordance with a further object of the invention, the method delay cross-linking reactions in aqueous systems, until the sol-gel polymerizes while drying.

It is still another object of this invention to use this composition as an additive to fluoropolymer aqueous dispersions to enhance the UV radiation resistance, curing and adhesion properties, alone or when reinforced with metal particles, carbon and glass fibers, woven fabrics or metal coating. The teachings of Elan (U.S. Pat. No. 6,251,521) indicate the need to add a UV absorbing agent to fluoropolymers.

In accordance with a further object of the invention, the sol-gel can be formed by the following process. First, contacting in the presence of atmosphere and at room temperature greater than one (>1) mole weight parts of diethylamine with one-half (½) mole weight parts of a C2 to C4 tetrafunctional titanate. This mixture is mixed in a container, for example, at three-hundred revolutions per minute (300 RPM) for fifteen minutes (15 min.). Then the translucent solution is admixed to twenty-nine (29.0) mole weight parts of water, which forms a hydrolyzed gelatinous agglomerate that will dissolve with continued agitation and heating. A mild exdotherm is noted. Next, the mixture is stirred at 300 RPM for thirty minutes (30 min.) while essentially heating the solution below the boiling point for fifteen minutes or until the solution becomes transparent. Next, the solution is allowed to cool to room temperature and filter any undissolved particles. The fluid is dark orange colored and turns straw in color when added to water. The amount of water utilized is critical to this invention: too little water and the composition will solidify later due to a condensation reaction.

In accordance with a further object of the invention, the invention provides a method for preparing aqueous titanate solutions from titanium chelates without requiring an acidic environment or developing turbidity.

To reap maximum benefit from sol-gel synthesis, -MOM′O— bond formation should be induced before or during the sol stage, otherwise, a mere mixture of the individual metal oxides could result.

A solution of sodium, boron, and silicon alkoxides when treated with water forms a stable sol before complete hydrolytic polycondensation and gel formation. In multicomponent systems containing more sensitive alkoxides, the mode of water addition is critical. In such cases, the less stable alkoxide(s) is usually added to a partially hydrolyzed solution of the more stable alkoxide. The preparation of silica-titania sols and borosilicate coatings utilizes this strategy.

### Brief Description of the Drawings:

FIG. 1 is bar graph comparing disease rating versus time for a blank, two different concentrations of sol-gel, and Bravo Weather Stick;

FIG. 2 is a graph plotting UV transmittance versus wavelength for a blank and and two different washes of the sol-gel;

FIG. 3 is graph plotting UV absorbance versus wavelenth for a blank, the two different washes of the sol-gel, and Tinuvin 1130;

FIG. 4 is a graph plotting UV transmittance versus wavelenth for the blank and the two different washes of the sol-gel;

FIG. 5 is a graph plotting UV absorbance versus wavelenth for the blank, the two different washes of the sol-gel, and Tinuvin 1130;

FIG. 6 is an Environmental Scanning Electron Microscopy (ESEM) image of a top of an untreated Ipomea carmea leaf at 276 times magnification;

FIG. 7 is an ESEM image of the top of the untreated Ipomea carmea leaf at 1015 times magnification;

FIG. 8 is an ESEM image of a bottom of the untreated Ipomea carmea leaf at 1907 times magnification;

FIG. 9 is an ESEM image of the bottom of the untreated ipomea carmea leaf at 1706 times magnification;

FIG. 10 is an ESEM image of the bottom of the untreated ipomea carmea leaf at 265 times magnification;

FIG. 11 is an ESEM image of a top of the untreated ipomea carmea leaf at 258 times magnification;

FIG. 12 is an ESEM image at 2000 times magnification of a bottom of an ipomea carmea leaf coated for five days;

FIG. 13 is an ESEM image at 4000 times magnification of the bottom of the ipomea carmea leaf coated for five days;

FIG. 14 is an ESEM image at 1600 times magnification of the bottom of a freshly coated ipomea carmea leaf;

FIG. 15 is an ESEM image at 800 times magnification of the bottom of the freshly coated ipomea carmea leaf;

FIG. 16 is an ESEM image at 1600 times magnification of the top of a freshly coated ipomea carmea leaf;

FIG. 17 is an ESEM image at 6400 times magnification of the top of a freshly coated ipomea carmea leaf;

FIG. 18 is an X-ray spectrum of an Ipomea carmea leaf without a coating;

FIG. 19 is an X-ray spectrum of an Ipomea carmea leaf with a coating;

FIG. 20 is an X-ray spectrum of an Ipomea carmea leaf with a coating after a water rinse; and

FIG. 21 is a diagramatic view of the folded sol-gel; and

FIG. 22 is a diagramatic view of the unfolded sol-gel.

### DESCRIPTION OF THE PREFERRED EMBODIMENTS

Preferred embodiments of the invention include transparent titanate films of sol-gels from aqueous systems for use as agrochemical thin film barrier compounds. The films must be multifunctional and inexpensive to use. These and other embodiments are addressed by this invention.

The film controls a coated plant's environment by protecting plant foliage and limiting exposure to adverse environmental conditions that reduce a plant's health. The film dries quickly without sintering or in-situ curing. The film resists UV radiation, mildew, and water.

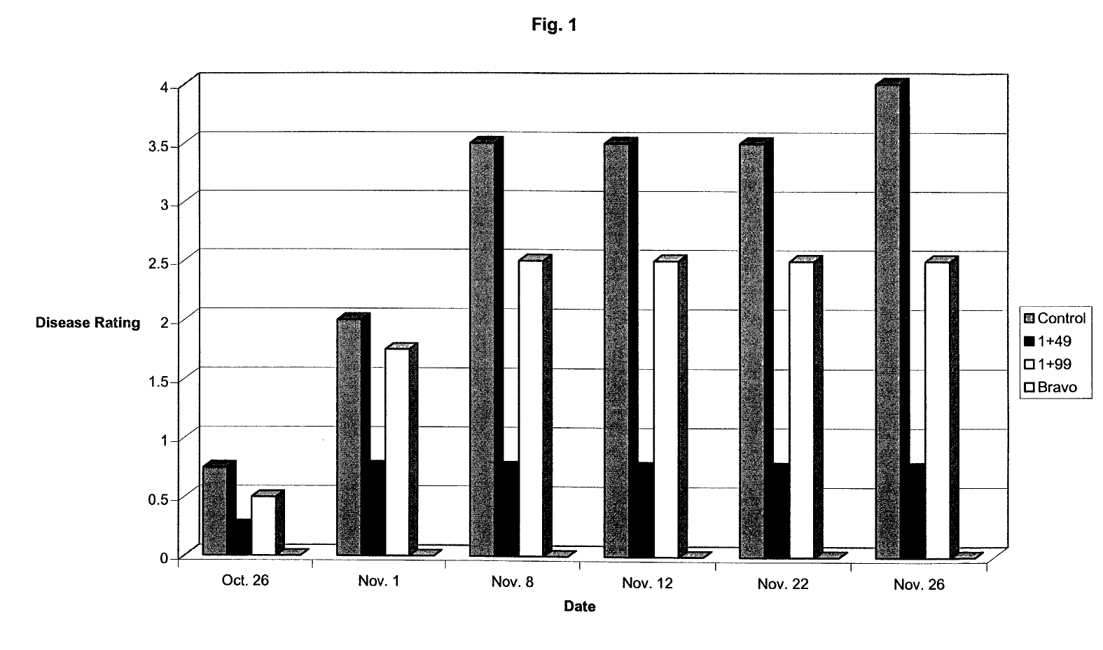

FIG. 1 is a chart showing the results of a Powdery Mildew test. The mildew rating is plotted versus time for four different samples. The mildew rating was quantified according to the following procedure:

| | |
|---|---|
| 0 | No sign of leaf infection; |
| 1 | 1-25% of leaves are infected; |
| 2 | 26-50% of leaves are infected; |
| 3 | 51-75% of leaves are infected; and |
| 4 | 76-100% of leaves are infected. |

The first sample was a control having no coating. The second sample was an application of the sol-gel dissolved to a concentration of 1:100. The third sample was an application of the sol-gel dissolved to a concentration of 1:50. The fourth sample was WEATHER STICK® at a concentration of 1:250. The samples were applied to Erysiphe chichoracearum. The plants were observed weekly.

The plants without a coating became diseased more quickly and more completely than the coated plants. The plants that were coated with a 1:100 solution of sol-gel were less diseased. In addition, the disease took longer to infect than uncoated plants. The plants coated with a 1:50 solution of sol-gel became infected slower than the control and the spread of the infection was ceased after one week at a disease rating of 0.75.

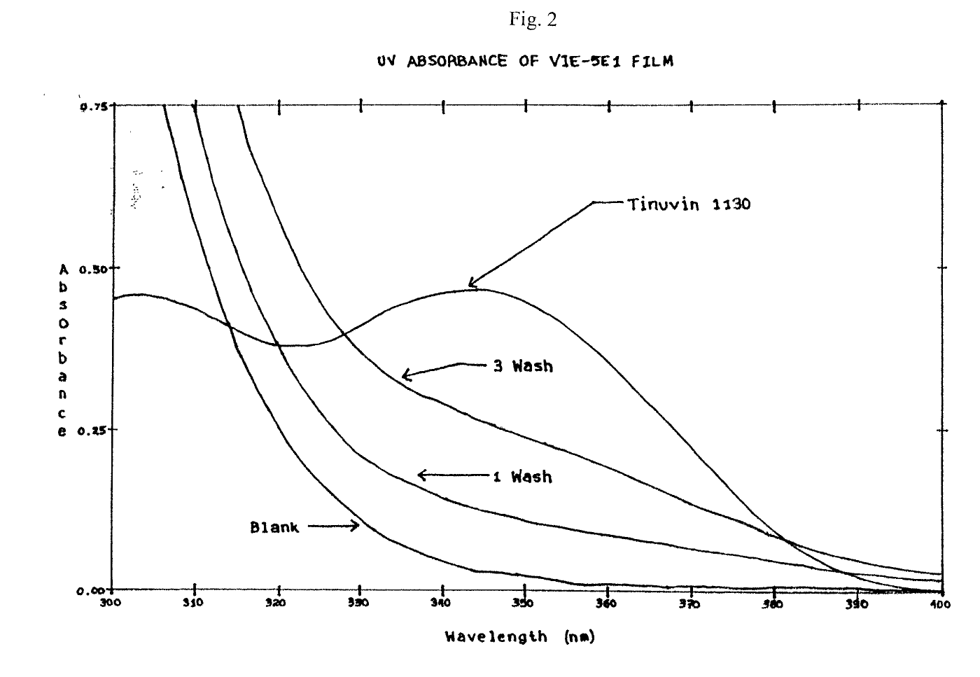

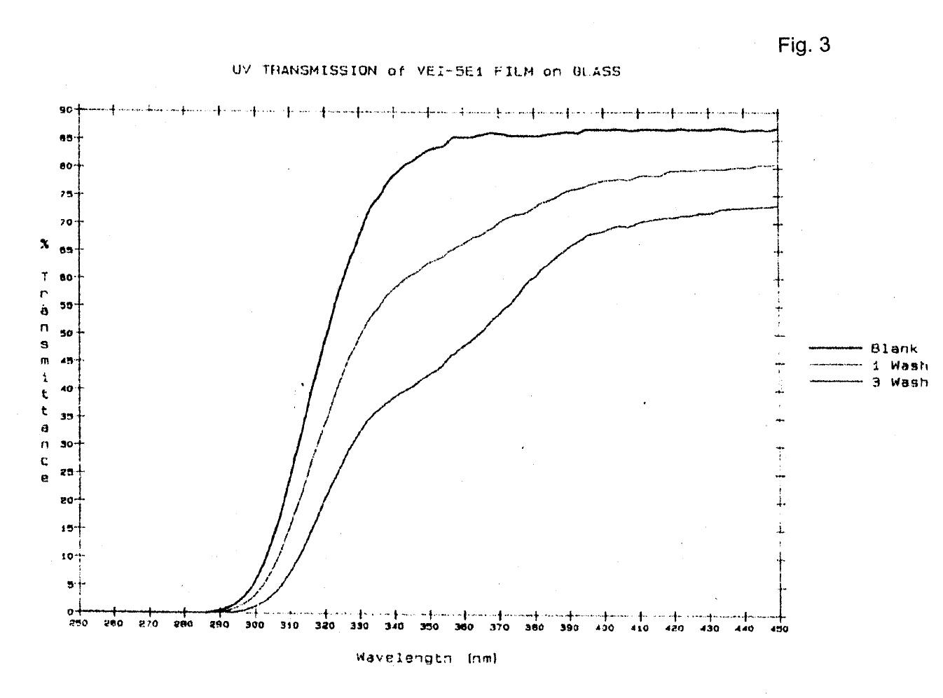

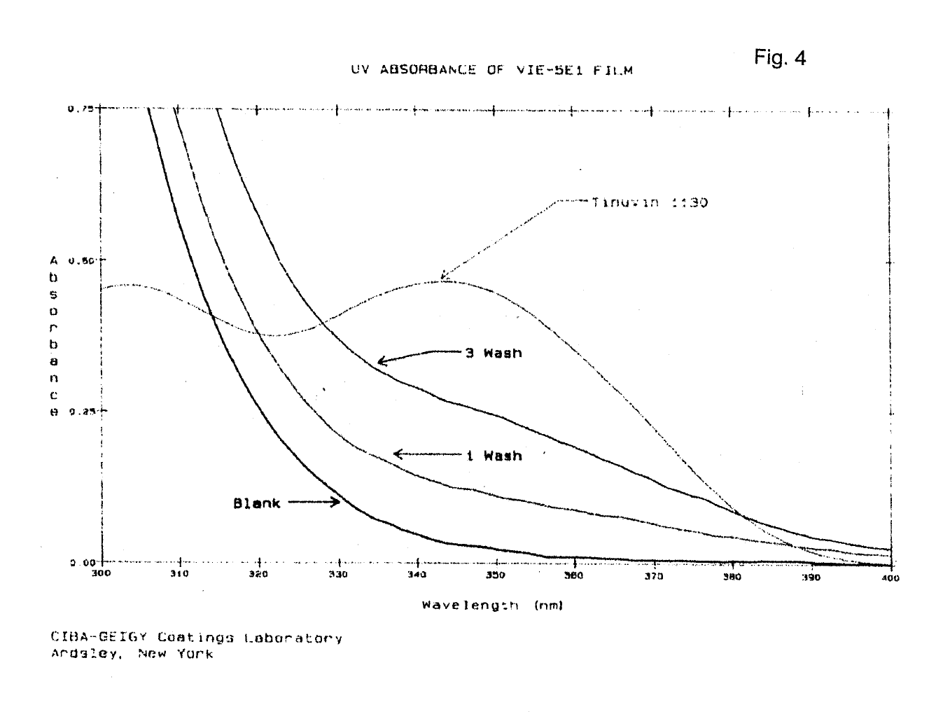

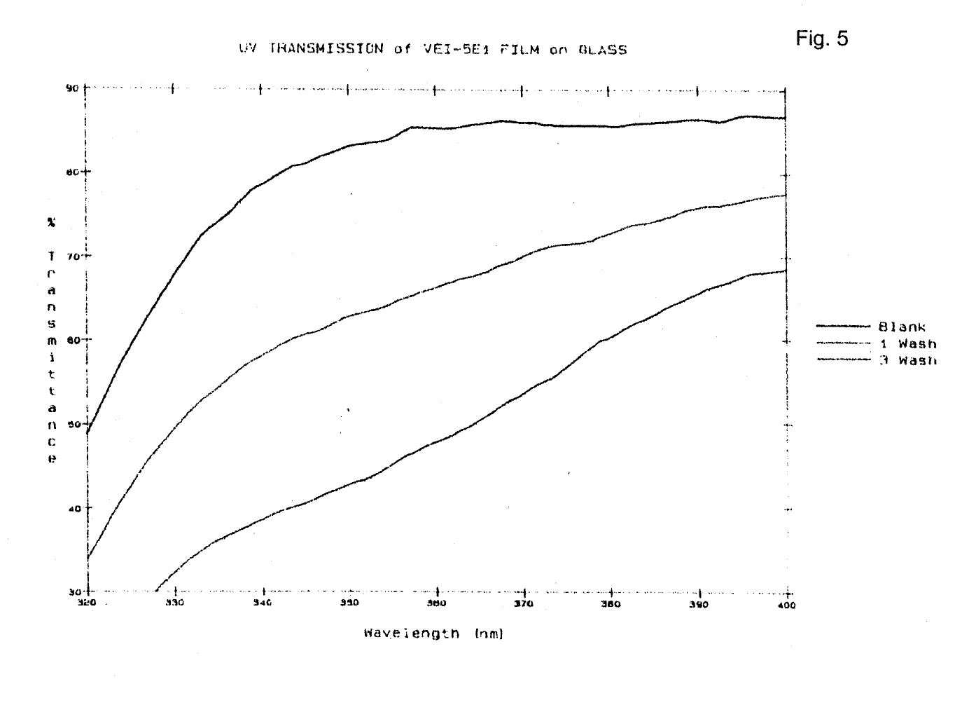

FIGS. 2-5 demonstrate that the sol-gel of the invention absorbs UV-radiation. FIGS. 2-5 show the transmittance and absorbance for two wavelengths of Ultra-violet light. FIGS. 2 and 4 tested absorbance and transmittance, respectively, for the UVA region of the spectrum ranging from 315-400 nm. FIGS. 3 and 5 tested absorbance and transmittance, respectively, for the UVB region reaching from 280 to 315 nm.

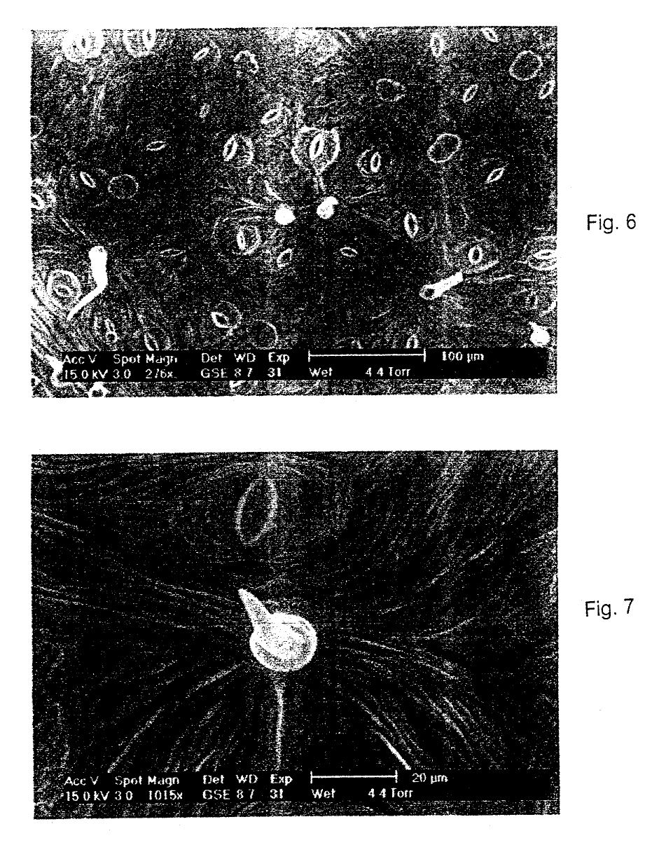

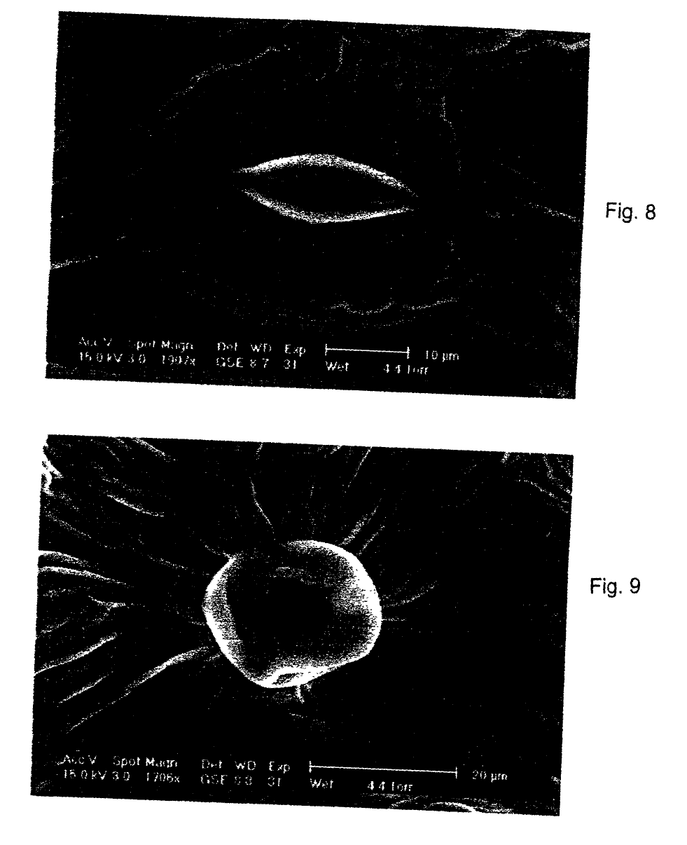

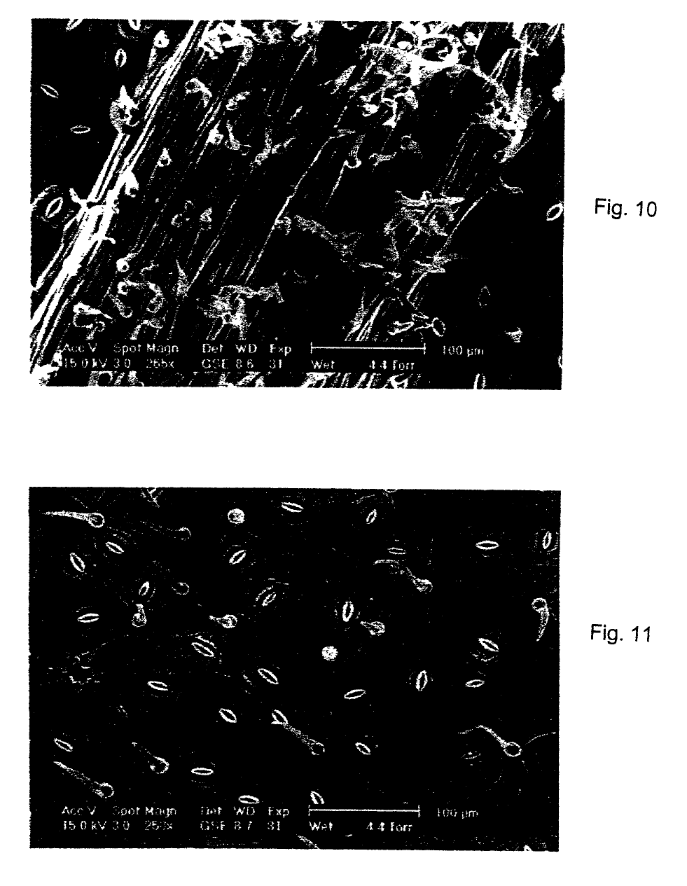

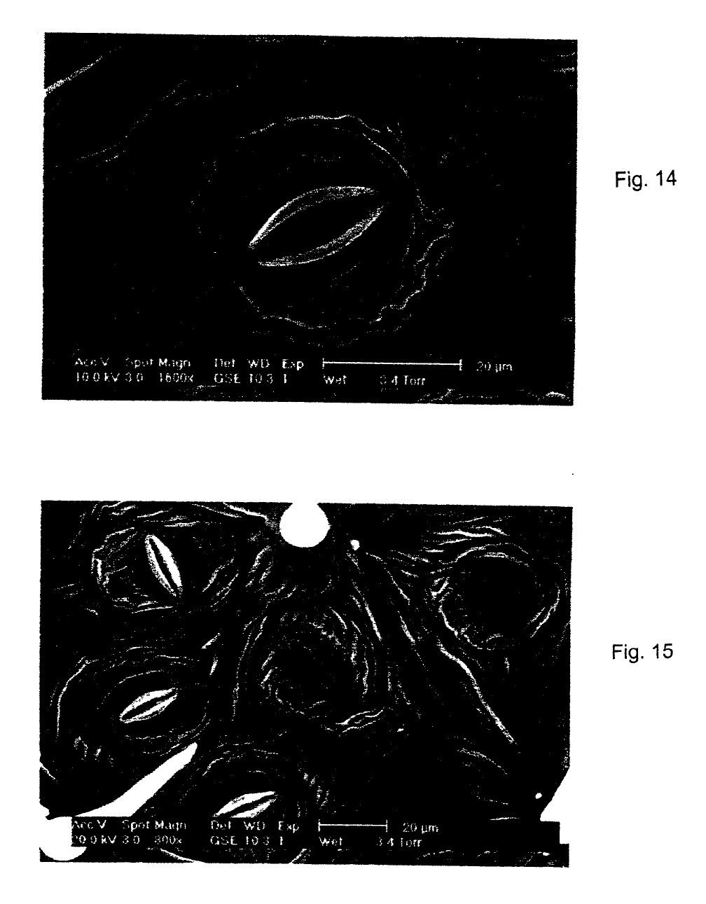

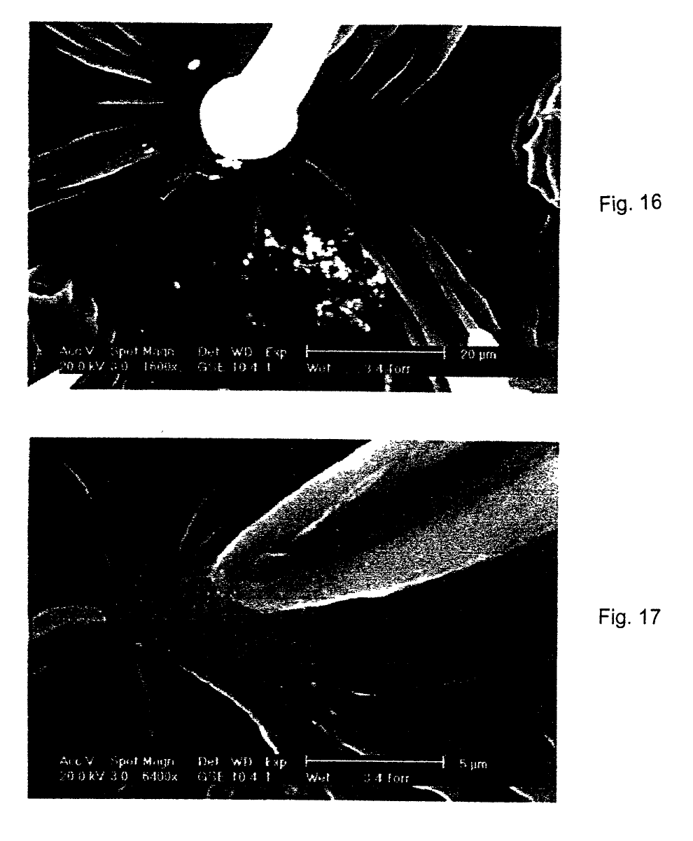

FIGS. 6-17 are images made with an environmental scanning electron microscope (ESEM). In order to observe the effect of the mixture on the leaves, plants were selected with leaves having easily-dicernable topography, size, and texture.

FIGS. 6-11 show untreated leaves. The stomata and hair are visable.

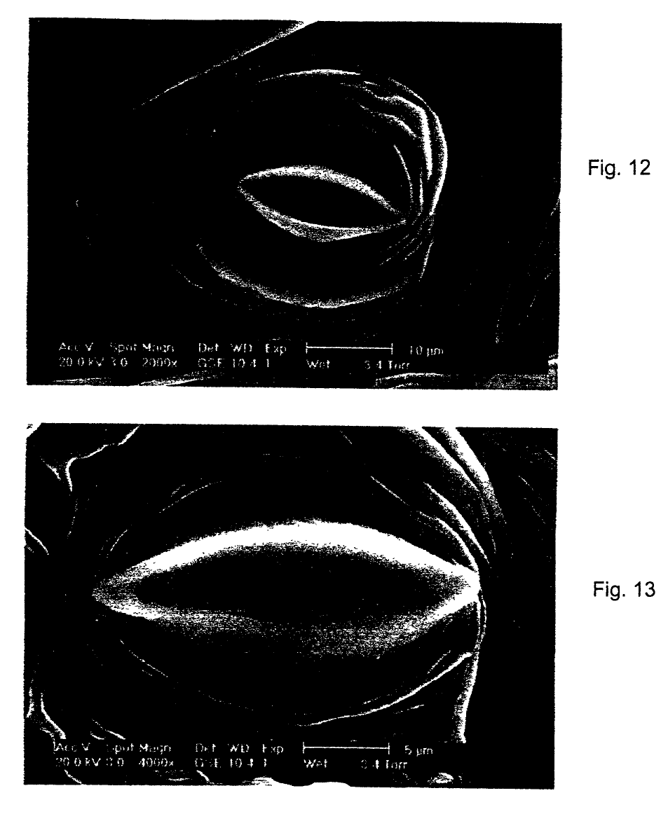

FIGS. 12-17 show leaves coated with the sol-gel. The images are taken at different times after the coating was applied.

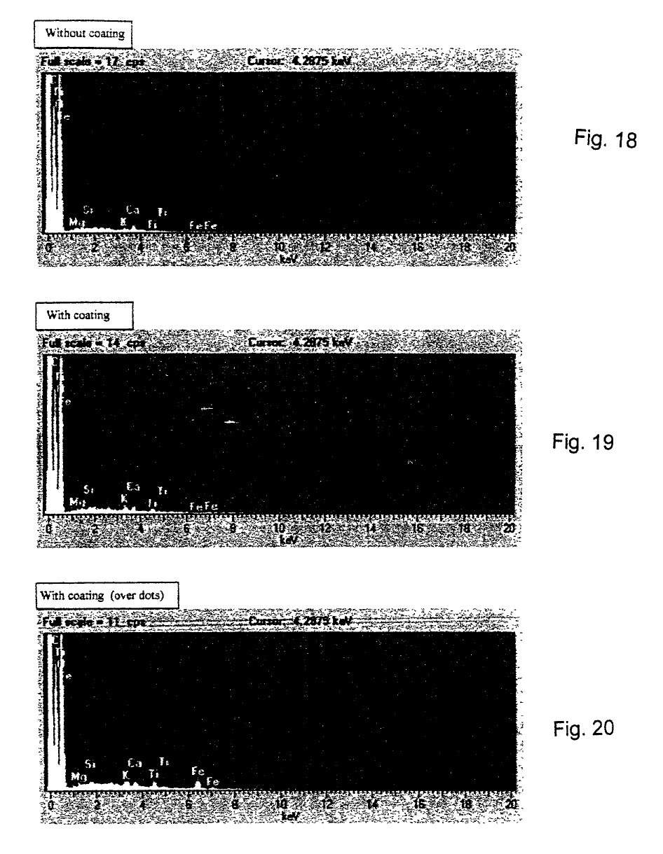

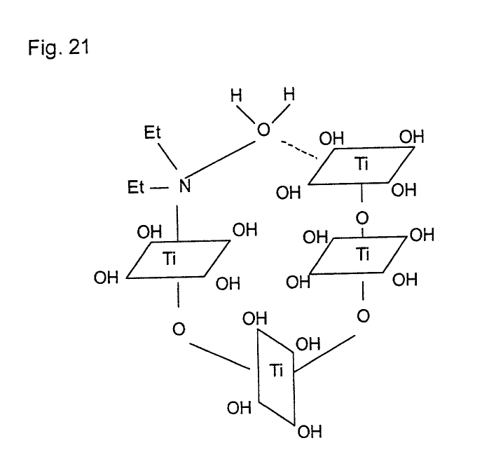

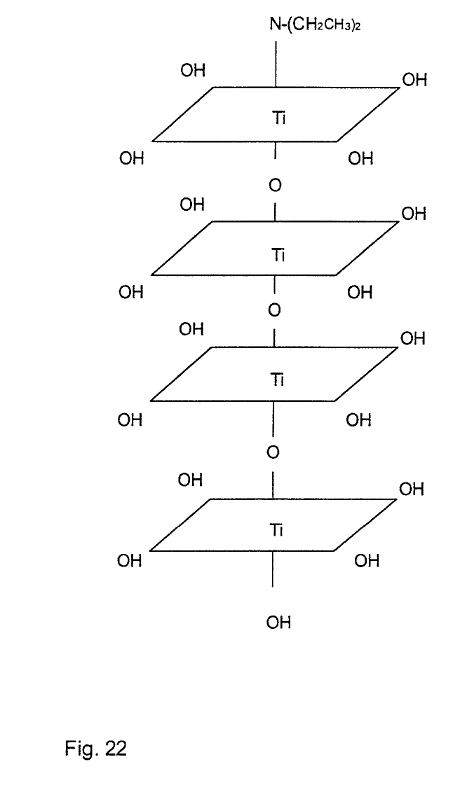

FIGS. 18-20 are X-ray spectra. The X-ray analysis was carried on over 3 different samples: a non-coated leaf in FIG. 18, a freshly-coated leaf in FIG. 19, and a coated leaf after a water rinse in FIG. 20. While the non-coated leaf does not show any evidence of a layer, the spectra corresponding to the treated leaves indicates clearly the presence of the layer with the titanium peak. In addition, in FIG. 20, the sample rinsed with water shows the presence of titanium. This observation indicates that the coating is water resistant.

Using a sol-gel barrier on plants reduces adverse environmental factors affecting plant development. Efficient plant production methods reduce reliance on, environmentally undesirable toxic pesticides. Additional chemicals can be incorporated such as UV sensitive pesticides. The sol-gel barrier coating when sprayed on plants provides a physical barrier to environmental damage. The coated surface helps to protect against adverse conditions such as: wind-borne soil, saltwater, and excessive ultraviolet-light exposure. Test results indicate that the sol-gel coating substantially inhibits the growth of powdery mildew of cucurbits. To reproduce and grow, this pathogen obtains nutrition by secreting an enzyme on plant tissue surfaces that dissolves the epidermal layer. The microorganism often invades grapes, cucurbits, and other plants.

The thin protective barrier that forms after drying is transparent, flexible, water repellent, nontoxic, and permits the free exchange of gases while not interfering with photosynthesis.

The sol-gel coating of the invention does not require the addition of a surfactant spray adjuvant (wetting agent) and resists removal by the wind and water.

The composition is economical: 50-to-l dilution in water.

It is an object of this invention that liquid compounds of this invention are alkaline, shelf-stable and have a high pH and not become turbid or polymerize while in storage.

In accordance with a further object of the invention, the sol-gel solves problems caused by antitranspirants that block plant foliar exchange of gases. The multifunctional properties of this invention that relates to thin film coatings that are porous to oxygen and carbon dioxide gas but bead water and is resistant to removal by rain.

The sol-gel coatings of the invention are thin film protective coatings that are hydrophobic and bead water while still allowing the plant to exchange gases. As pressure to reduce water use from non-agricultural sections increase exploring alternative approaches to improve plant water efficiency becomes even more important. Active leaf transpiration is necessary for normal physiological plant processes and is necessary for adequate yields.

By applying a thin UV protective film to the surface of the leaf, the total solar incident radiation is reduced thus sustaining respiration rates. A sol-gel thin film protective coating of the invention has the advantage over anti-transpirant coatings by not interfering with stomatal closure and the regulation of internal leaf temperature. The use reduces plant canopy temperatures and improves plant yields when compared to untreated plants.

Sol-gel ratios affect the severity of powdery mildew on cucumbers. Cucumbers throughout most of the world are susceptible to powdery mildew, which has been recognized since the 1800s. However, some cultivars have proved to be resistant to this mildew. Powdery mildew affects cucumbers from the time when they are young up to harvest date. Powdery mildew is discriminating in that it requires a live host to survive, instead of media used in isolation in the laboratory. The cucumber cultivar “Comet” was used in a plant protector trial inside a greenhouse for comparison of four different chemical treatments against the common foliar fungal disease, Powdery mildew caused by Erysiphe cichoracearum. A sol-gel was applied in two different concentrations, 1:50 and a 1:100. The other two treatments used were BRAVO WEATHER STICK® (4 mls/liter), which is a fungicide manufactured by GB Bioscience Corporation, and an untreated control (water). A randomized block design was used within each of four greenhouse benches. Each plot contained four six-inch (6″) pots with two plants that were spaced 95 cm apart and replicated four times. All treatments were sprayed one day before inoculation. Seedlings in the second true leaf stage were inoculated in the greenhouse by direct application of spores. All spray treatments were applied weekly. Disease evaluations were made at approximately seven-day intervals. The mildew rating was 0 for completely healthy plants to 4 for abundant development of the disease over the leaf surface.

All of the treatments were more effective than the check for powdery mildew control (FIG. 1). The treatments seemed to be more effective over time. One week after inoculation, powdery mildew became visible on the control and the sol-gel at 1:100 plots. Fifteen to nineteen days after inoculation, the cotyledons and hypocotyl of the control and the sol-gel at 1:100 were heavily infected with E. cichoracearum. The sol-gel at 1:50 began to show powdery mildew by the second week; however, the disease was not as severe. Marginal burns became visible on the 1:50 treatments, but the new growth was normal after being fertilized with PETERS® 20-20-20® in the fourth week. BRAVO WEATHERSTIK® never showed any visible signs of powdery mildew. This experiment was important because the chemical used is not a fungicide but rather a plant protectant, which acts as a barrier on the leaf.

These objects and other objects of this invention are achieved by the process and products of this composition. The process for making the composition includes contacting in the pressence of atmosphere pressuric and at room temperature, greater than one (>1.0) mole weight parts of diethylamine with 0.50 mole weight parts of a C₂ to C₄ tetrafunctional titanate and mix in container at 300 RPM for fifteen (15) minutes. Then admix the translucent solution to 29.0 mole weight parts of water, which forms hydrolyzed gelatinous agglomerate that will dissolve with continued agitation and heating. A mild exdotherm is noted. Stir at 300 RPM for 30 minutes while essentially heating the solution below the boiling point for 15 minutes or until the solution becomes transparent. Allow cooling to room temperature and filter out any undissolved particles. The fluid is dark orange colored and turns straw in color when added to water. The amount of water utilized is critical to this invention: to little water and the composition will solidify later due to a condensation reaction.

### EXAMPLE 1

The following is a first preffered embodiment of the composition and process for manufacturing the sol-gel:

Add and mix in order in atmosphere at 25 C. Weight in Grams

| | |
|---|---|
| A. Doethylamine | 73.20 |
| B. Isopropyl Titanate | 142.00 |
| C. Stir @ 300 RPM for 15 minutes | 215.20 |
| D. Water | 533.20 |
| E. Stir @ 300 RPM for 30 minutes | 738.40 Total |
| F. Heat solution below boiling point for 15 minutes or until | |
| dissolved. | |
| G. Let cool to room temperature and filter. | |
| H. Close container and store prior to use. | |

### EXAMPLE 2

A second preferred embodiment of the composition and method for manufacturing the sol-gel is the following:

| | |
|---|---|
| A. Diethylamine | 73.20 |
| B. Ethyl titanate | 114.00 |
| C. Stir @ 300 RPM for 15 Minutes | 187.20 |
| D. Water | 523.20 |
| E. Stir @ 300 RPM for 30 Minutes | 710.40 Total |
| F. Heat solution below a boil for 15 minutes or until | |
| dissolved | |
| G. Let cool to room temperature and filter. | |
| H. Close container and store prior to use. | |

### EXAMPLE 3

The following example is a third preferred embodiment of the composition and method of manufacturing the sol-gel:

| | |
|---|---|
| A. Diethylamine | 73.20 |
| B. Butyl titanate | 340.00 |
| C. Stir @ 300 RPM for 15 minutes | 413.20 |
| D. Water | 533.20 |
| E. Stir @ 300 RPM for 30 minutes | 936.4 Total |
| F. Heat solution below a boil for 15 minutes or until | |
| dissolved | |
| G. Let cool to room temperature and filter. | |
| H. Close container and store prior to use. | |

### EXAMPLE 4

The following is an example of a method of manufacturing the sol-gel including a Fluoropolymer. From 0.1 to 5.0% of sol-gel is admixed to a fluoropolymer dispersion. Once the additive is combined with the fluoropolymer dispersion, the mixture is stable. Three days later slight coalescence is noted. After 6 months, the compound was still fluid: stir well before using. Initial screening tests of a sol-gel modified, PTFE aqueous dispersion and stainless steel 316 fibers, were dip coated, and flash dried at 250° F. and sintered for ten minutes at 610° F. When compared to the control sample, the resultant fiber composites demonstrated significantly improved fiber adhesion and hardness, over the unmodified PTFE aqueous dispersion control used to dip coat the (SS) stainless steel fibers and then sintered at 610° F. The tests conducted were side by side and in the same furnace in the presents of atmosphere, and at the melting point of the PTFE.

### EXAMPLE 5

The following is an example of a sol-gel including PTFE and the method for making it. One and one half percent (1.5%) by weight of sol-gel neat was admixed to 98.5% by weight of 307A, PTFE aqueous dispersion and let sit for 24 hours at room temperature (75° F.) before testing. The above testing protocal initial screening tets of a sol-gel modified PTFE aqueous dispersion and stainless steel 316 fibers that were dip coated, and flash, dried at 250° F., and sintered for ten (10) minutes at 610° F. When compared to the control sample, the modified samples demonstrated increased shear resistance to cutting and increased resistance to fiber penetration by a stainless-steel metal pointed probe. The improvement was estimated to be greater than fifty percent (>50%). The high temperature properties to direct flame were also improved.

### Example 6

A sol-gel 1.0 volume to 100.0 volumes water diluted sol-gel composition was sprayed on stainless steel metal fibers and dried producing a thin film coating that also promoted metal adhesion to aqueous PTFE dispersions the same test protocol with the control fluoropolymer dispersion. The adhesion improvement was estimated to be thirty percent (30%).

### EXAMPLE 7

Additional testing using the same test protocol as above was conducted on fluoropolymer dispersion called PFA 335. The stainless steel fibers were replaced by stainless steel (“SS”) 316 woven cloth NP250. The SS cloth was dip coated in a two percent (2%) sol-gel modified PFA 335 liquid dispersion and the excess coating dripped off. The control SS samples used PFA 335 neet and were processed as above. After sintering, the modified samples demonstrated improved shear resistance to cutting and increased resistance to fiber penetration by a SS metal pointed probe. The improvement adhesion was estimated to be greater than fifty percent (>50%). The high temperature properties were also improved. The improved adhesion would account for the enhancements to the SS fiber test samples fiber to fiber strength.

I claim:

1. A method for manufacturing a sol-gel, which comprises:
providing a dialkylamine;
mixing the dialkylamine with an alkoxide;
admixing water to form a hydrolyzed gelatinous agglomerate; and
heating and stirring the hydrolyzed gelatinous agglomerate until the hydrolyzed gelatinous agglomerate becomes transparent.

2. The method according to claim 1, which further comprises using two molar weight parts of the dialkylamine for each molar weight part of the alkoxide.

3. The method according to claim 1, which further comprises using at least 29 molar weights of water for each molar weight of the diethylamine.

4. The method according to claim 1, which further comprises filtering out any undissolved particles from the translucent hydrolyzed gelatinous agglomerate.

5. The method according to claim 1, wherein the metal alkoxide is a C2 to C4 tetrafunctional titanate.

6. The method according to claim 1 wherein the metal alkoxide is a tetraisopropyl titanate.

7. The method according to claim 1 wherein the metal alkoxide is selected from the group consisting of tetraethyl, tetrapropyl, and tetrabutyl titanate.

8. The method according to claim 1, wherein the method further comprises diluting the translucent hydrolyzed gelatinous agglomerate with up to 100 volumes of water.

9. The method according to claim 1, which further comprises using diethylamine as the dialkylamine.

10. A sol-gel having the formula:
—N(x)₂-[(TiOH₄)—O]ₙ—,
wherein
x is an alkyl group; and
n is an ordinal number.

11. The sol-gel according to claim 10, where x is selected from the group consisting of methyl, propyl, and butyl.

12. The sol-gel according to claim 10, where x is an ethyl group.

13. The sol-gel according to claim 10, where n equals 4.

14. A sol-gel having the formula:
—N(x)₂-[(TiOH₄)—O]ₙ—
wherein
x is an alkyl group; and
n is an ordinal number;
made by providing a dialkylamine; mixing the dialkylamine with an tetrafunctional titanate; admixing water to form a hydrolyzed gelatinous agglomerate; stirring and heating the hydrolyzed gelatinous agglomerate until the hydrolyzed gelatinous agglomerate becomes transparent.

15. A method for forming a protective barrier for a plant, which comprises coating a plant with a sol-gel having the formula:
—N(x)₂-[(TiOH₄)—O]ₙ—,
wherein
x is an alkyl group; and
n is an ordinal number.

16. A method for protecting tile, which comprises coating a tile with a sol-gel having the formula:
—N(x)₂-[(TiOH₄)—O]ₙ—,
wherein
x is an alkyl group; and
n is an ordinal number.

17. A method for protecting grout, which comprises coating grout with a sol-gel having the formula:
—N(x)₂-[(TiOH₄)—O]ₙ—,
wherein
x is an alkyl group; and
n is an ordinal number.

18. A method for carrying ultraviolet-light-sensitive pesticides, which comprises:
providing a sol-gel having the formula:
—N(x)₂-[(TiOH₄)—O]ₙ—,
10 wherein
x is an alkyl group; and
n is an ordinal number; and
adding an ultraviolet-light-sensitive pesticide.

19. A method for preparing fluoropolymer dispersions, which comprises:
providing a fluoropolymer dispersion; and
adding a sol-gel having the formula:
—N(x)₂-[(TiOH₄)—O]ₙ—,
10 wherein
x is an alkyl group; and
n is an ordinal number.

20. The method according to claim 19, which further comprises maintaining a concentration of sol-gel from 0.1% to 5.0% weight percent of the fluorocarbon dispersion.
